(19) United States
(12) Patent Application Publication
(10) Pub. No.: US 2022/0107255 A1
(43) Pub. Date: Apr. 7, 2022

(54) GOBLET VISCOMETER

(71) Applicant: Abductive Services LLC, Bryan, TX (US)

(72) Inventor: Paul Chike Ofoche, Bryan, TX (US)

(73) Assignee: Abductive Services LLC, Bryan, TX (US)

(21) Appl. No.: 17/063,903

(22) Filed: Oct. 6, 2020

(51) Int. Cl. G01N 11/04

(52) U.S. Cl. CPC G01N 11/04; G01N 2011/0006

(57) ABSTRACT

The present disclosure provides a viscometer for measuring rheological properties of a fluid, based on the fluid level decreasing at a constant rate during efflux, including a vessel with a three dimensional shape defined by the following proportionality

$$x ∝ C \times {y}^{( \frac{1}{n} )}$$

wherein, the symbol ∝ refers to a proportionality, and the variables x and y are coordinates on an x-y cartesian coordinate plane, where x is length and y is height; and n is a variable exponential term between and including 2 and 4; and C is a constant with dimensions of length; and where the vessel comprises a hole at or near the y-coordinate minimum.

### BACKGROUND OF THE DISCLOSURE

### Field of the Invention

This disclosure is generally directed to viscometers, and more particularly goblet viscometers.

### Description of the Related Art

Current state of the art for the measurement of fluid rheology provides complicated, sophisticated, laboratory equipment that is not practical or readily available for field use or for many industrial applications. Furthermore, currently available laboratory rheology equipment is not capable of making real time, continuous, fluid rheology measurements in the field and other various flow conditions.

Accordingly, there is a need for quicker and more accurate methods of measuring fluid rheology, continuously and in real time, both in the field and in laboratory settings.

### SUMMARY OF THE INVENTION

The present disclosure provides a viscometer for measuring rheological properties of a fluid including a vessel with a shape defined by the following proportionality: x∝C∜y wherein, the symbol ∝ refers to a proportionality, and the variables x and y are coordinates on an x-y cartesian coordinate plane, where x is length and y is height, and C is a constant with dimensions of length, and where the vessel comprises a hole at or near the y-coordinate minimum.

The disclosed fluid viscometer and software provides textbook accuracy to field and industrial rheology measurement applications. The textbook definition of shear rate for measuring fluid rheology is achieved by this invention, which can be frequently repeated in a real-time and continuous manner with minimal error. Results like those obtained with much more sophisticated laboratory equipment are readily obtained on the fly and at any location. The disclosed fluid viscometer is simple, yet more precise than other more complicated laboratory devices.

The disclosed software can also be used to provide a system for instantaneous prediction and display of various shear rates as determined from the disclosed viscometer for measuring fluid viscosity under various flow conditions. Extreme precision may be attained with the disclosed viscometer and by applying this new method. Another problem solved is that real-time and continuous measurement of fluid rheology can be achieved.

The disclosed fluid viscometer includes a proportionality in the shape of the viscometer vessel which may be dimensioned to ensure that the height of the liquid poured into the viscometer falls at a constant rate, in other words, the disclosed viscometer maintains a constant rate of decline of the volume flow rate. This aspect of the flow guarantees that a precise flow rate can be determined at any point in time. The textbook definition of shear rate can thus be determined and together with fluid density, readings equivalent to those obtained from conventional, more sophisticated, devices can be attained from this invention. Furthermore, the size, height and capacity of the viscometer can be varied, while maintaining the proportionality, to require less fluid volume for real-time rheology measurements as needed.

The disclosed software can be used in a system providing instantaneous prediction and display of various shear rates, like those determined from conventional rheometers, used for measuring fluid viscosity under various flow conditions.

The invention provides precise knowledge of volumetric flow rate across all sections of the viscometer at any point in time. This enables for precise determination of shear rates and exact matching and comparison with conventional rheometers used in laboratory environments. Using statistical techniques implemented in the disclosed software, the purported industry standard dial readings for describing rheology can be reported instantly.

The disclosed system is inexpensive and can easily be integrated into any industrial or field setting without any disruptions. Much less volume can be flown through this device to determine the fluid's complete rheological profile in fractions of the time required by other methods, thereby making this invention suitable for real-time fluid rheology measurement.

Other features and aspects will be apparent from the following detailed description, the drawings, and the claims

### BRIEF DESCRIPTION OF THE DRAWINGS

FIG. 1 shows an embodiment of a viscometer of the disclosure.

FIG. 2A shows another embodiment of a viscometer of the disclosure.

FIG. 2B shows another embodiment of a viscometer of the disclosure.

FIG. 2C shows another embodiment of a viscometer of the disclosure.

FIG. 3 illustrates an embodiment of a measurement from a viscometer of the disclosure.

FIG. 4 shows estimated volumetric flow of a water sample.

FIG. 5 shows estimated volumetric flow of a glycerol sample.

FIG. 6 shows estimated volumetric flow of a cornstarch solution.

FIG. 7 shows an embodiment of the software display of the present disclosure.

FIG. 8 shows another display of the software of the present disclosure.

FIG. 9 shows a flowchart showing operation of the software of the present disclosure.

FIG. 10 shows adjusting the shape of the vessel for adaptability to different fluid types.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The disclosed invention hinges on a special case of Torricelli's Law, which describes the relationship between the speed of fluid jet outflowing from an opening to the height of the fluid column above the orifice. The disclosed invention generalizes the theorem to extend to real fluids of various viscosities which have different coefficients of discharge, accounting for effects of turbulence.

To precisely account for the flow rates and flow profile across a container, it is important to determine a means of decreasing the fluid level at a constant rate.

For the fluid level to decrease at a constant rate, the mathematical representation is:

$$\frac{Change of fluid height}{Time interval} = \frac{d ( {height}_{container} )}{d ( time )} = {constant}_{rate} \qquad ( Eq .1 )$$

By considering a barrel-shaped or tubular container with a radial cross-section, at any fluid level, the fluid surface area is: (π×radius_{container}²).

By applying the concepts of differential calculus, the instantaneous rate of change in fluid volume is:

$$\begin{matrix}\frac{d ( Volume )}{d ( time )} = ( Fluid surface area ) \times \frac{d ( {height}_{container} )}{d ( time )} & ( Eq .2 ) \\ = π \times {( {radius}_{container} )}^{2} \times {constant}_{rate} & ( Eq .3 )\end{matrix}$$

Adapting Torricelli's law to real fluid applications by introducing a coefficient of discharge, and noting g as the gravitational constant, the instantaneous volumetric rate of flow exit is:

$$\begin{matrix}\frac{d ( Volume )}{d ( time )} = {Area}_{orifice} \times {coefficient}_{discharge} \times velocity & ( Eq .4 ) \\ = {Area}_{orifice} \times {coefficient}_{discharge} \times \sqrt{2 \times g \times {height}_{container}} & ( Eq .5 )\end{matrix}$$

By equating Eq. 3 and Eq. 5:

Area_{orifice}×coefficient_{discharge}×\sqrt{2×g×height_{container}}=π×(radius_{container})²×constantᵣₐₜₑ (Eq. 6)

We have that:

$${height}_{container} = \frac{{π}^{2} \times {( {constant}_{rate} )}^{2}}{2 \times g \times {( {Area}_{orifice} )}^{2} \times {( {coefficient}_{discharge} )}^{2}} \times {( {radius}_{container} )}^{4} \qquad ( Eq .7 )$$

A close inspection of the right-hand side of Eq. 7 reveals that all the terms are either constants or intrinsic fluid properties.

Thus, the proportional relationship between the radius and height of the container is established.

Mathematically:

height_{container}∝((radius_{container})⁴ (Eq. 8)

Alternatively:

$${radius}_{container} ∝ \sqrt[4]{{height}_{container}} \qquad ( Eq .9 )$$

The proportionality sign (∝) in Eq. 9 means that it can be converted into an equation by applying a proportionality constant term, to obtain Eq. 10.

$${radius}_{container} = {constant}_{proportionality} \times \sqrt[4]{{height}_{container}} \qquad ( Eq .10 )$$

Eq. 10 is applicable to water and a wide range of fluids of low viscosity. To account for fluids of much higher viscosities, the exponential term is varied and would approach Eq. 10a for fluids with very high viscosity (e.g. glycerol).

radius_{container}=constant_{proportionality}×\sqrt{height_{container}} (Eq. 10a)

More generally, the Eq. 10b is applied to this invention, where the container radius, proportionality constant, container height and exponential term (n) are variable within the range specified herein.

$${radius}_{container} = {constant}_{proportionality} \times {( {height}_{container} )}^{\frac{1}{n}} \\ where 2 \leq n \leq 4 \qquad ( Eq .10 b )$$

This proportionality provides that any fluid placed inside the container and allowed to drain by gravitational force will have the level decreasing at a constant, which provides that the volumetric flow rate has a constant deceleration. Hence, the constant of proportionality can be adjusted as desired to achieve any size, height, or capacity (volume) for a vessel while maintaining the exponential relationship between the container's radius and height, as shown in the drawings.

This feature enables the container or vessel shapes to be adjusted or downsized to smaller volumes for rapidly draining fluids in desired fractions of time to ascertain their flow behavior and enhance real-time, automated, and continuous, measurement of a fluids' physical characteristics, such as rheology, viscosity, and density.

In embodiments, the volume of the disclosed viscometer vessel may be between about 10 cm³ and about 7500 cm³. In embodiments, the volume of the disclosed vessel may be between about 500 cm³ and about 1000 cm³. In embodiments, the volume of the disclosed vessel may be between about 10 cm³ and about 250 cm³. In embodiments, the volume of the disclosed vessel may be between about 1000 cm³ and about 5000 cm³.

In embodiments, the diameter of a hole at the bottom of the vessel may be between about 0.1 cm and 2 cm. In embodiments, the diameter of a hole at the bottom of the vessel may be between about 1 cm and 1.5 cm.

Therefore, the exact volumetric flow rate is known across the entire container and the shear rates at any time and location can be calculated using the formula in Eq. 11 below:

$$Shear Rate ( {s}^{- 1} ) = \frac{4 \times ( Volumetric Flow Rate )}{π \times {( {radius}_{container} )}^{3}} \qquad Eq .11$$

The exact shear rates so determined can be equated and made to correspond to those obtained from conventional rheometers, thereby reporting the dial readings accordingly. For instance, conventional rheometers used in the petroleum industry report dial readings at these standard shear rates at the corresponding rotational speeds.

When coupled and used in tandem with a weight balance, the density of fluids can also be determined simultaneously in real-time by applying this invention, as is shown in the drawings, whereby mass flow rates and densities are measured simultaneously. The container is filled to a pre-determined volume which has been calibrated with water. In so doing, the densities of any other fluid drained through the container can be determined.

Human error is removed. The same pre-determined volume of fluid simply needs to be placed into the container each time which is then allowed to drain by gravitational force. A single output is recorded which is the drain time used to derive the remainder of the readings.

The disclosed viscometer can be used as a stand-alone device or coupled with associated software to output and display dial readings at all the desired shear rates.

The invention can also be applied to measure the gel strengths (gelation) of fluids by vigorously agitating the fluid sample of pre-determined volume, allowing it to rest at a static condition for a chosen time, and measuring the desired shear rates based on drain time.

The exact shear rates so determined can be equated and made to correspond to those obtained from conventional rheometers or any other desired shear rates, thereby reporting standard dial readings accordingly. For example, conventional rheometers used in the petroleum industry report dial readings at the following standard shear rates at the corresponding rotational speeds.

| | |
|---|---|
| 3 RPM −> | 5.11 s⁻¹ |
| 6 RPM −> | 10.21 s⁻¹ |
| 100 RPM −> | 170.23 s⁻¹ |
| 200 RPM −> | 340.46 s⁻¹ |
| 300 RPM −> | 510.69 s⁻¹ |
| 600 RPM −> | 1021.38 s⁻¹ |

The size, height and capacity of the viscometer can be adjusted, while maintaining the proportionality to require less fluid volume for real-time rheology measurement and other purposes, as illustrated in the drawings. The viscometer can be made from any suitable material including plastics, composites, resins, glass, etc., clear or see-through materials are preferred.

The disclosed viscometer can also be connected to an industrial setting whereby the filling and draining of fluids in the vessel can be automated. The device can be fabricated by various methods known in the art for making, for example, funnel viscometers, and includes but is not limited to 3D printing.

In embodiments, the disclosure further provides software which may be used with the disclosed viscometers to measure fluid rheological properties easily and accurately without the need to use sophisticated laboratory rheological equipment.

The disclosed software reports and displays readings of fluid rheology under different flow conditions simultaneously. The readings reported are equivalent to those obtained from conventional rotational rheometers which are currently the industry standard. The current technology makes use of sophisticated equipment which is not readily available or frequently utilized during industry operations and field processes. The current state of the art technology requires time to operate and analyze the rheology measurements which are too infrequently obtained. Thus, proper monitoring of fluid rheology in a frequent manner is not possible using currently available technology.

This invention solves the longstanding problem by providing software that readily displays and plots rheological properties graphically under different flow conditions based on simple inputs of fluid density and of fluids through a viscometer. This invention simplifies the monitoring of fluid rheology and helps to ensure the proper monitoring and measurement of fluid rheological profiles. It makes rheology reports instant and more frequently obtained.

This invention includes machine learning algorithms and a software application for mobile phones, tablets, computers, graphical and visual display units, dashboards, etc. that takes two (2) input values, i.e. fluid density and drain time through the disclosed viscometer to output rheological readings which are dial readings equivalent to conventional direct-indicating rotational rheometers. This invention displays the dial readings at several rotational speeds (3-600 RPM) or corresponding shear rates which would equivalently be obtained from a conventional 6-speed rheometer. The software application additionally displays the multiple readings in a graph, thereby making it easy for users to visualize the rheological properties of fluids. Other derivative values for describing fluid rheology, including yield point, plastic viscosity, apparent viscosity, and wall shear stress values determined analytically are also reported instantly by the disclosed software.

The disclosed software provides ease of use. Simply entering two input values of density and viscometer drain time produces multiple values that would be obtained from a conventional rotational rheometer. The inventive software can be utilized on mobile phones, tablets, computers, graphical and visual display units, dashboards, etc. Current state of the art technology is not capable of reporting rheological readings under different flow conditions. A conventional rotational rheometer would have to be operated each time to obtain measurements of fluid rheology, however, this invention simplifies the process by making the rheological values readily available based on only two reading inputs. This invention would be advantageous in a variety of operational environments, such as the petroleum industry, food processing industry, cement industry, etc., where frequent monitoring and measurement of fluid rheology is required.

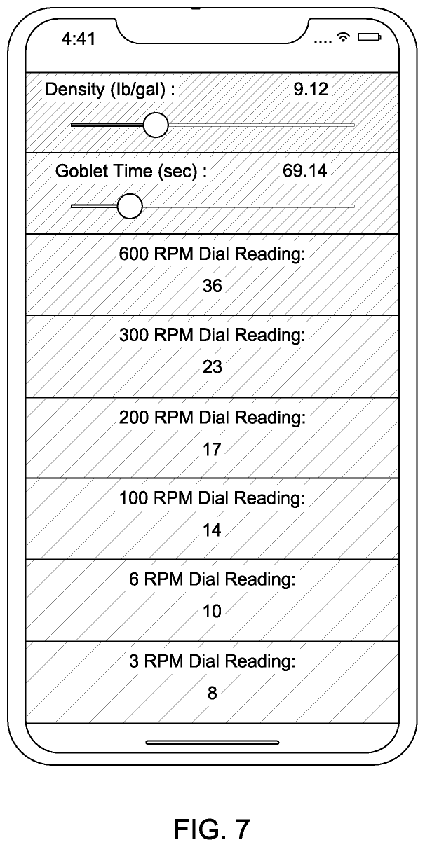

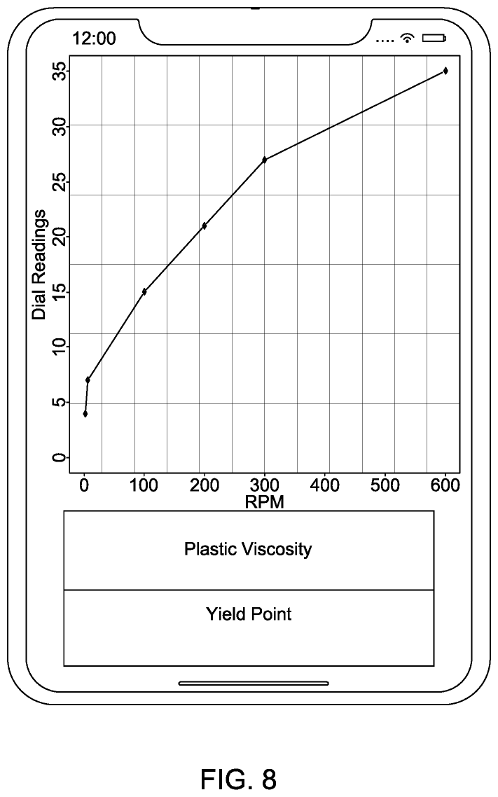

This invention can be implemented on various hardware, including but not limited to, mobile phones, tablets, laptop computers, desktop computers, graphical and visual display units, dashboards, etc. that include memory and a processor. The primary output readings obtained are the 3, 6, 100, 200, 300 and 600 RPM dial readings (equivalent to those of a conventional rotational rheometer), plastic viscosity, yield point and apparent viscosity, as well as a graph showing these values. Additional values of choice can also be displayed. See e.g., FIG. 7 and FIG. 8.

In embodiments, the fluid level decreases at a constant rate during efflux, enabling for exact determination of the flow rate and associated shear rates across all sections of the vessel.

In embodiments, machine learning algorithms and statistical techniques for inferring interpretations based on the viscosity (flow time) and fluid density of measuring the rheological properties of a liquid may be used. This includes but is not limited to ensemble tree algorithms, (Extreme) Boosted Trees, Bootstrap Forests, Artificial Neural Networks, Support Vector Machines, and Polynomial Regression.

In embodiments, the exact shear rates so determined from this invention can be equated and made to correspond to those obtained from conventional rheometers, thereby reporting the dial readings accordingly. For instance, conventional rheometers used in the petroleum industry report dial readings at these standard shear rates at the corresponding rotational speeds.

In embodiments, when coupled and used in tandem with a weight balance, the density of fluids can also be determined simultaneously in real-time by applying this invention, as is shown in the drawings, whereby mass flow rates and densities are measured simultaneously. The container is filled to a pre-determined volume which has been calibrated with water. In so doing, the densities of any other fluid drained through the container can be determined on-the-fly.

In embodiments, human error is minimized, and instrument error is eliminated. The invention relies solely on gravitational free fall. The same pre-determined volume of fluid simply needs to be placed into the container each time which is then allowed to drain by gravitational force. A single output is recorded which is the drain time used to derive the remainder of the readings.

In embodiments, the size (radius), height and capacity of the viscometer can be varied, while maintaining the proportionality of the vessel's shape, to require less fluid volume for real-time and continuous rheology measurements as needed.

In embodiments, the invention can also be applied to measure the gel strengths (gelation) of fluids by vigorously agitating the fluid sample of pre-determined volume, allowing it to rest at a static condition for a chosen time, and measuring the desired shear rates based on drain time.

In embodiment, a container tips over and fills the goblet, then tips back. The goblet may have a plate or flapper blocking the bottom of it that closes when the container tips over to fill, and then opens when the container tips back to vertical. When the container is vertical, it will refill with the fluid continuously being measured.

When the plate or flapper pulls away from the tip of the goblet, the fluid is released from the goblet and a timer (e.g. a stopwatch) is simultaneously started. Depending on the need, the drained fluid could be collected and weighed dynamically on a weight balance to determine the density of the fluid additionally. Once the goblet is empty, a sensor may click the stopwatch and the timing is stopped. The collection device is then emptied, and the time is reported to the system, which is used by a machine learning algorithm to immediately report the inferred fluid's rheological profile.

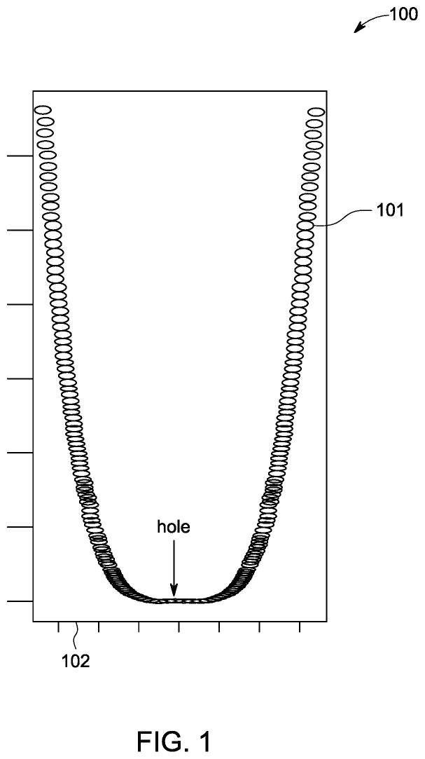

FIG. 1 shows a viscometer vessel 100 of the disclosure. FIG. 1 shows vessel 101 and a cartesian coordinate system 102 which may be used to describe the shape of the vessel.

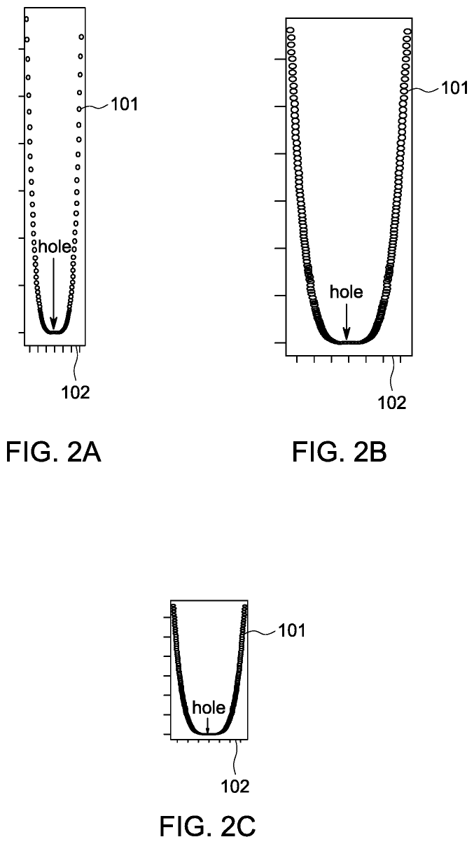

FIGS. 2A, 2B, and 2C show viscometer vessels of the disclosure and illustrate examples of how the size and shape of the vessel may be varied.

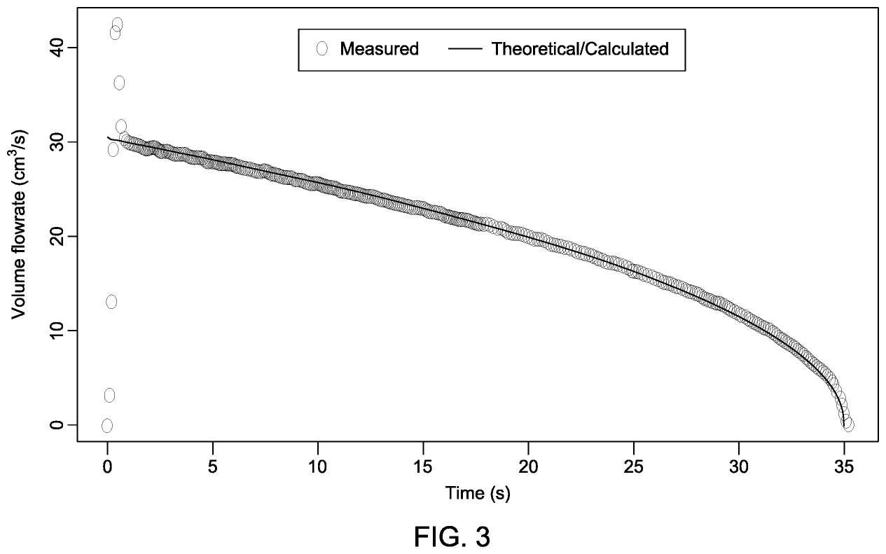

FIG. 3 shows a measured versus theoretical calculated flow for a water sample. In FIG. 3, the volume drained was 710.11 cm³ and the density was 1.0 g/cm³.

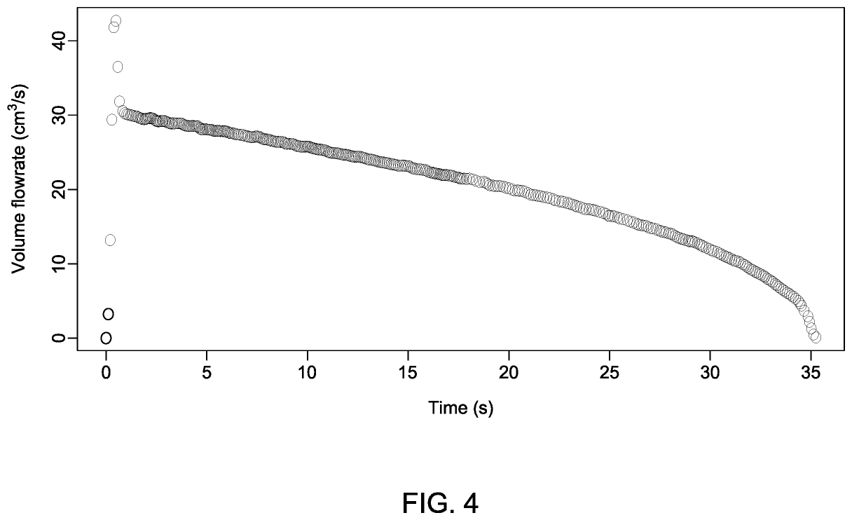

FIG. 4 shows an estimated volumetric flow of a water sample dynamically measured by a weight balance. The volume drained was 710.11 cm³ and the density was 1.0 g/cm³.

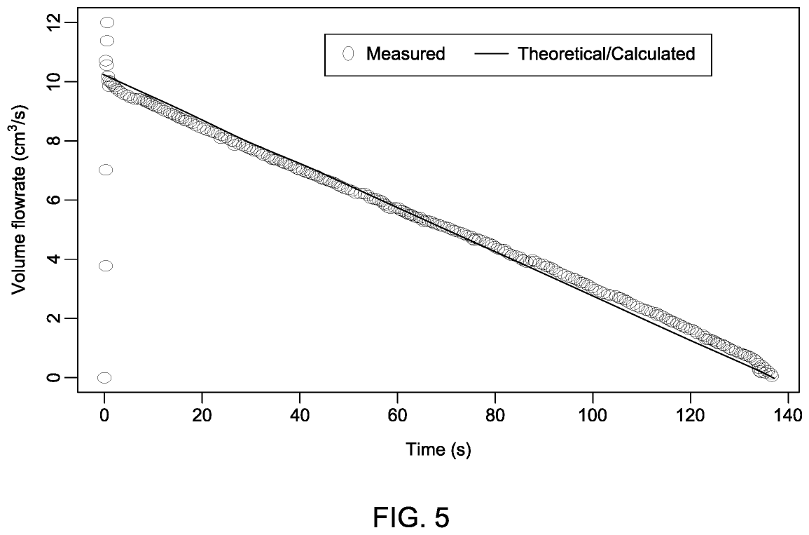

FIG. 5 shows a measured versus theoretical calculated flow of a glycerol sample. In FIG. 5, the volume drained was 699.79 cm³ and the density was 1.293 g/cm³.

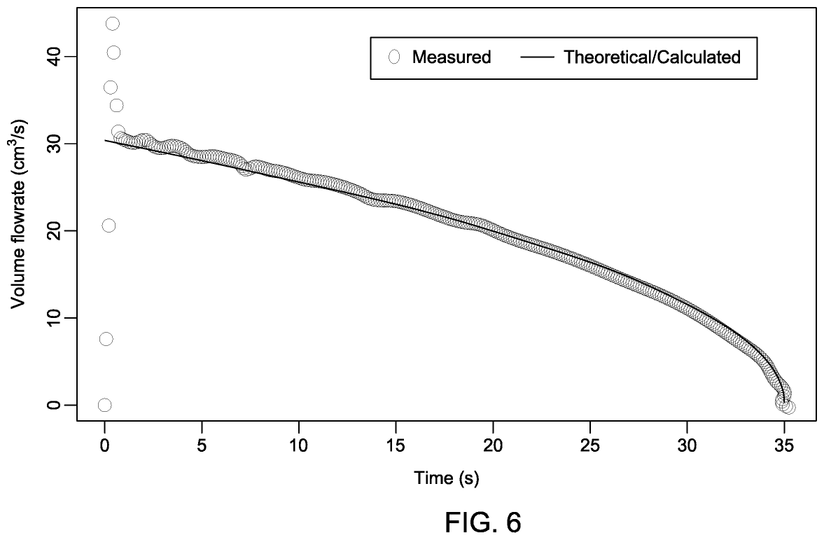

FIG. 6 shows a measured versus theoretical calculated flow of a cornstarch solution. In FIG. 6, the volume drained was 710.11 cm³ and the density was 1.1185 g/cm³.

FIG. 7 shows an embodiment of the software display of the present disclosure.

FIG. 8 shows another display of the software of the present disclosure.

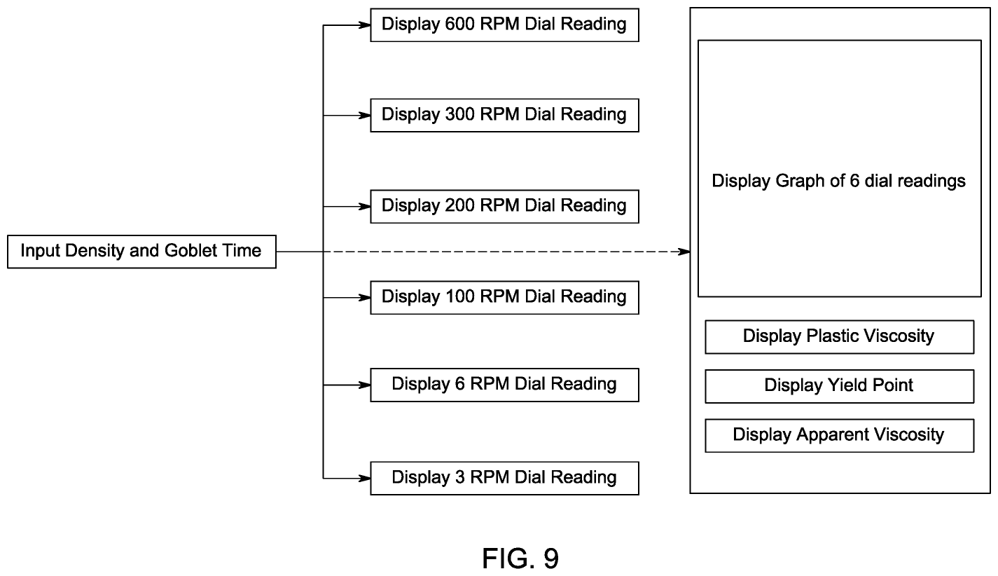

FIG. 9 shows a flowchart showing operation of the software of the present disclosure.

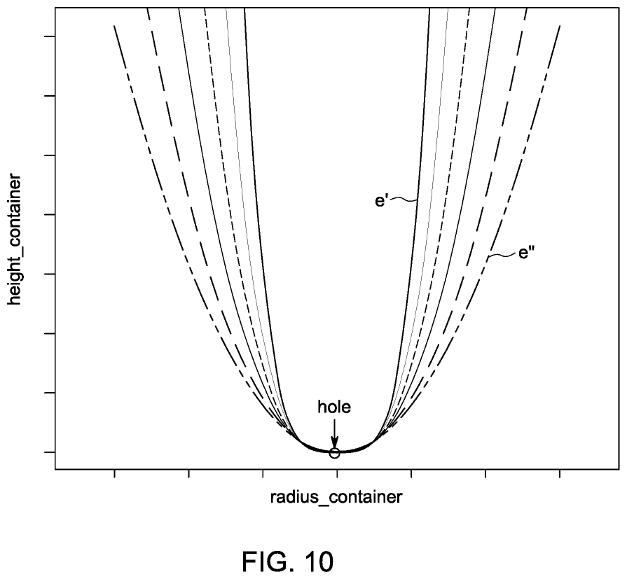

FIG. 10 shows how the shape of the vessel can be adjusted based on changing the exponential term.

FIG. 10 illustrates how the shape of the vessel can be adjusted for adaptability to different fluid types, thus a broad range of applications by changing the exponential term. In FIG. 10, e′=0.25 in the equation below. When e=0.25 a low viscosity fluid such as water may be measured. When e=0.5 a high viscosity liquid such as glycerol may be measured. For an intermediate value for e, a moderate viscosity fluid such as a drilling fluid may be used.

radius_{container}∝(height_{container})^{exponent}

radius_{container}=constant_{proportionality}×(height_{container})^{exponent}

where 0.25≤exponent≤0.5

(Note that the range of the exponent is from inviscid to highly viscous fluids respectively)

where 0.1≤constant_{proportionality}≤4

or expressed alternatively,

$${radius}_{container} = {constant}_{proportionality} \times {( {height}_{container} )}^{\frac{1}{n}}$$

where 2≤n≤4

where 0.1≤constant_{proportionality}≤4

where 10 cm≤height_{container}≤100 cm

where 0.1 cm≤hole_{diameter}≤1.25 cm

### Example 1

Exact match between theoretically calculated flow rates and experimentally measured values (as shown in FIG. 3) verifies the precision of this invention. Always being equipped with exact knowledge of the vessel's diameter across the entire sections enables the application of the nominal wall shear rate equation (Eq. 11)

$$Shear Rate ( {s}^{- 1} ) = \frac{4 \times ( Volumetric Flow Rate )}{π \times {( {radius}_{container} )}^{3}}$$

to obtain the textbook definition of shear rate and hence precisely match those obtained from conventional viscometers.

An added advantage with this technique is that the dimensions of the vessel can be scaled down to much smaller volumes (capacities) to allow for rapid draining of fluids in the vessel and deriving the exact same desired values from the flow. This aids real-time measurements and is amenable to automation.

### Example 2

FIG. 4 shows estimated volumetric flow of a water sample dynamically measured by a weight balance.

### Example 3

FIG. 5 shows estimated volumetric flow of a glycerol sample dynamically measured by a weight balance.

### Example 4

FIG. 6 shows estimated volumetric flow of a cornstarch solution dynamically measured by a weight balance.

While this disclosure includes specific examples, it will be apparent after an understanding of the disclosure of this application has been attained that various changes in form and details may be made in these examples without departing from the spirit and scope of the claims and their equivalents.

1.-17. (canceled)

18. A viscometer for measuring rheological properties of a fluid comprising a vessel with a shape defined by the following proportionality:
$$x ∝ C \times {y}^{( \frac{1}{n} )}$$
wherein, the symbol ∝ refers to proportionality, and the variables x and y are coordinates on an x-y cartesian coordinate plane, where x is length and y is height; 2≤n≤4; and C is a constant with dimensions of length; and wherein the vessel comprises a hole at or near the y-coordinate minimum.

19. The viscometer of claim 18, wherein the volume of the vessel is between about 10 cm³ and 5000 cm³.

20. The viscometer of claim 18, wherein the volume of the vessel is between about 500 cm³ and 1000 cm³.

21. The viscometer of claim 18, wherein the diameter of the hole is between about 0.1 cm and 1.5 cm.

22. The viscometer of claim 18, wherein the diameter of the hole is between about 0.1 cm and 1.25 cm.

23. The viscometer of claim 18, wherein the viscometer comprises polyethylene.

24. The viscometer of claim 18, wherein the viscometer comprises glass or pyrex.

25. The viscometer of claim 18, wherein the viscometer comprises a resin.

26. The viscometer of claim 18, wherein the viscometer comprises a see-through material.

27. The viscometer of claim 18, wherein the vessel shape is defined by the following proportionality:
$$x ∝ C \sqrt[4]{y}$$
wherein the variables are as defined in claim 1.

28. A system for measuring the rheological properties of a liquid comprising:
the viscometer of claim 1; and
a software application for a mobile display device, tablet, computer, comprising memory and a processor configured to perform operations comprising:
accepting two input numerical values including density and viscosity measured by the viscometer of claim 1;
and outputting between 1 and 6 industry standard dial readings.

29. The system of claim 28, wherein the industry standard dial readings comprise: shear rates at dial reading of 3 RPM, 6 RPM, 100 RPM, 200 RPM, 300 RPM, and 600 RPM, wherein RPM refers to rotations per minute as defined by a conventional rheometer.

30. The system of claim 28, wherein the software application is for a cellular phone.

31. The system of claim 28, wherein the software application is configured to display a plot of dial readings vs. plastic viscosity and yield point.

32. The system of claim 28, wherein the system further outputs fluid density.

33. The system of claim 28, wherein the system further outputs the gel strength of a fluid.

34. The system of claim 28, wherein the software application performs operations including machine learning algorithms and statistical techniques including Ensemble tree algorithms, (Extreme) Boosted Trees, Bootstrap Forests, Artificial Neural Networks, Support Vector Machines, and/or Polynomial Regression.

35. The system of claim 28, wherein the system further outputs the wall sheer stress.
